(19) United States
(12) Patent Application Publication
(10) Pub. No.: US 2017/0068126 A1
(43) Pub. Date: Mar. 9, 2017

(54) FILTERING DEVICE AND DISPLAY DEVICE INCLUDING THE SAME

(71) Applicant: SAMSUNG ELECTRONICS CO., LTD., Suwon-si (KR)

(72) Inventors: Yu-li SUNG, Goyang-si (KR); Marzio Severino RIBOLDI, Codogno (IT); Pier Paolo CAPESTRANI, Desio (IT); Jae-won KIM, Seoul (KR); Ji-gwang KIM, Seoul (KR); Giulia REDI, Sinalunga (IT)

(73) Assignee: SAMSUNG ELECTRONICS CO., LTD., Suwon-si (KR)

(21) Appl. No.: 15/257,120

(22) Filed: Sep. 6, 2016

(30) Foreign Application Priority Data
Sep. 3, 2015 (KR) 10-2015-0125121

(51) Int. Cl. G02F 1/1335; H04R 1/02

(52) U.S. Cl. CPC G02F 1/133504; H04R 1/023

(57) ABSTRACT

A display device that can prevent moiré pattern is provided. The display device includes a display panel configured to display an image; a transmission member which is arranged in front of the display panel and transfers light which is projected from the display panel to express the image; and a diffusion member which is arranged between the display panel and the transmission member, diffuses the light, and transfer the diffused light to the transmission member.

### CROSS-REFERENCE TO RELATED APPLICATION

This application claims priority from Korean Patent Application No. 10-2015-0125121, filed on Sep. 3, 2015 in the Korean Intellectual Property Office, the disclosure of which is incorporated herein by reference in its entirety.

### BACKGROUND

Field

One or more exemplary embodiments relate to a filtering device for a display, and more particularly, to a filtering device which can implement an image in the overall atmosphere and can prevent moiré pattern.

Description of the Related Art

In general, a liquid crystal display (LCD) is widely used to display an object, such as a text, an image, and a moving image. For displaying such objects, the LCD uses the electro-optic characteristics of liquid crystals.

Such liquid crystals enable the LCD to display an object by adjusting permeability of external light in accordance with an electric field applied thereto. That is, the LCD requires light to display objects using the liquid crystals.

The LCD may use light that is created through consumption of electric energy that is charged in the LCD itself or external light that is created from an outside of the LCD.

If light can be supplied through consumption of electric energy charged in the LCD itself, it is possible to display an object in any place regardless of the surrounding environment of the LCD, for example, an amount of available light.

### SUMMARY

One or more exemplary embodiments overcome the above disadvantages and other disadvantages not described above, and provide a display device that can display an image clearly in various environments.

Exemplary embodiments may also provide a display device that can prevent moiré information.

According to an aspect of an exemplary embodiment, there is provided a display device including: a display panel configured to display an image; a transmission member which is arranged in front of the display panel and transfers light which is projected from the display panel to express the image; and a diffusion member which is arranged between the display panel and the transmission member, diffuses the light, and transfers the diffused light to the transmission member.

The diffusion member is attached to a front surface portion of the display panel, and wherein the transmission member is arranged to be spaced apart from the diffusion member for a predetermined gap distance.

The transmission member may be made of a fabric material.

The transmission member may have a plurality of through-holes that are penetratingly formed in a thickness direction of the transmission member.

The through-holes may be in a rectangular shape and may be arranged in a mesh pattern.

The diffusion member may be a diffusion film that diffuses the light emitted from the display panel.

The display device may further include a cover frame surrounding the transmission member to support the transmission member, the cover frame being detachably attached to the display panel.

The display device may further include a spacer which is arranged between the diffusion member and the transmission member, and adjusts a gap distance between the diffusion member and the transmission member.

The transmission member and the diffusion member may have shapes corresponding to a front surface of the display panel.

The display device may further include a sound portion arranged on the same side as the display panel, wherein the transmission member is installed to accommodate the display panel and the sound portion.

According to another aspect of an exemplary embodiment, there is provided a filtering device including: a diffusion member configured to diffuse light which is projected from a display panel to express an image; and a transmission member configured to transfer the light diffused by the diffusion member.

The transmission member may have a plurality of through-holes that are penetratingly formed in a thickness direction of the transmission member.

The plurality of through-holes may be in a rectangular shape and may be arranged in a mesh pattern.

The transmission member may be made of a fabric material.

The filtering device may further include a diffusion film which is attached to the diffusion member and re-diffuses the light diffused by the diffusion member.

The diffusion film may have a plurality of beads that heighten luminance of light which is emitted from the display panel vertically to the diffusion member.

### BRIEF DESCRIPTION OF THE DRAWINGS

The above and/or other aspects will be more readily appreciated from the following description of the exemplary embodiments with reference to the accompanying drawings, in which:

FIG. 1 is a view schematically illustrating a display device according to an exemplary embodiment;

FIG. 2 is an exploded view of the display device illustrated in FIG. 1;

FIG. 3 is a cross-sectional view of the display device illustrated in FIG. 1;

FIG. 4 is an enlarged view of a diffusion member illustrated in FIG. 3;

FIG. 5 is a view illustrating a display device according to an exemplary embodiment;

FIG. 6 is a view schematically illustrating a display device according to an exemplary embodiment;

FIG. 7 is a front view of the display device illustrated in FIG. 6;

FIG. 8 is a view schematically illustrating a display device according to an exemplary embodiment;

FIG. 9 is an exploded view of the display device illustrated in FIG. 8;

FIG. 10 is a view schematically illustrating a display device according to an exemplary embodiment;

FIG. 11 is a front view of the display device illustrated in FIG. 10; and

FIG. 12 is a view illustrating a screen of a display device according to an exemplary embodiment.

### DETAILED DESCRIPTION OF EXEMPLARY EMBODIMENTS

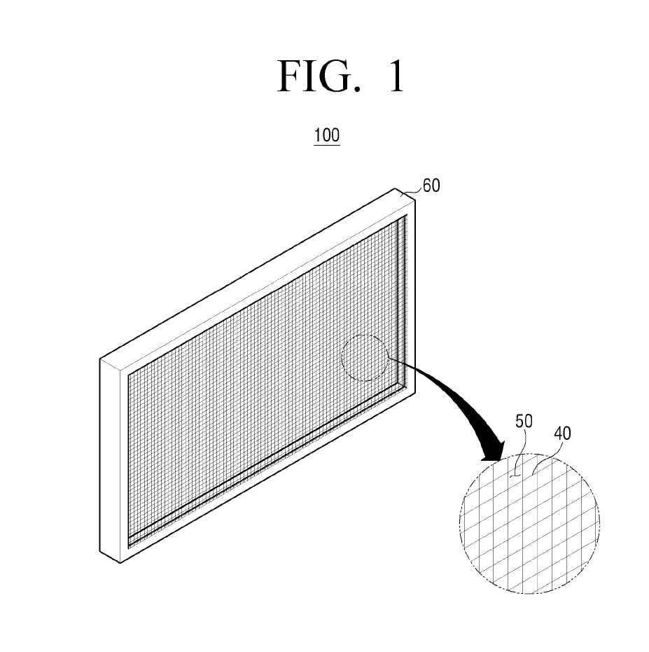

Hereinafter, exemplary embodiments will be described in detail with reference to FIGS. 1 to 12. The exemplary embodiments will be described based on the most suitable embodiments to understand the inventive concept. The technical features of the inventive concept are not limited to the described exemplary embodiments.

Accordingly, those of ordinary skill in the art will recognize that various changes and modifications of the various exemplary embodiments described herein can be made without departing from the scope and spirit of the present disclosure. Further, to help understanding of the embodiments to be described in the description of the present disclosure, the same or similar drawing reference numerals are used for the same or similar constituent elements across various figures.

On the other hand, a display device that is used in an exemplary embodiments may be variously applied to a large-scale display device that implements RGB using pixels in a lattice pattern, such as a PDP (Plasma Display Panel) device, an OLED (Organic Light Emitting Diode) device, an LCD (Liquid Crystal Display) device, or a FED (Field Emission Display) device, a PDA (Personal Digital Assistants), a small mobile display device, such as a small game machine display window or a portable phone display window, and a flexible display device.

Further, the display device according to the exemplary embodiments may be effectively applied to an outdoor display device that is exposed to a strong external light as well as an indoor display device that is installed in public facilities.

Hereinafter, various exemplary embodiments may be applied to not only the above-described various display devices and filters used in the display devices, but also other various devices.

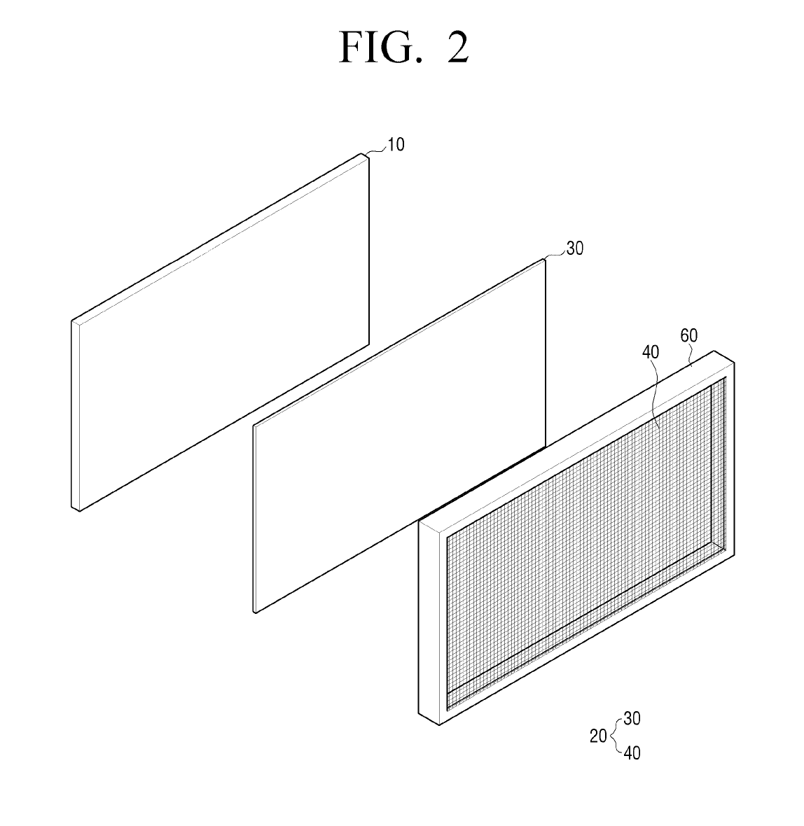

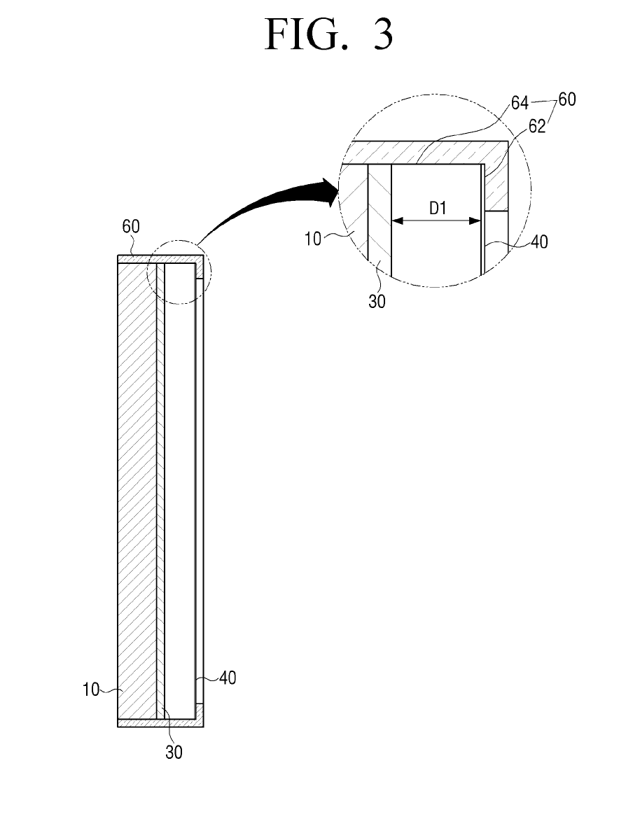

FIG. 1 illustrates a display device according to an exemplary embodiment. FIG. 2 is an exploded view of the display device illustrated in FIG. 1, and FIG. 3 is a cross-sectional view of the display device illustrated in FIG. 1.

As illustrated in FIGS. 1 to 3, a display device 100 may include a display panel 10 configured to display an image (e.g., video information) to a user, and a filter device 20 arranged in front of the display panel 10. The filter device 20 may include a transmission member 40 arranged in front of the display panel 10, and a diffusion member 30 arranged between the display panel 10 and the transmission member 40.

The display device 100 may further include a backlight unit arranged in the rear of the display panel 10. The backlight unit may emit light in the direction of the display panel 10.

For example, one linear polarized light, which is emitted from the backlight unit and passes through a polarizing plate, may be incident light to a liquid crystal layer. By changing the direction of a liquid crystal director through driving of an electric field, polarization of the light that passes through the liquid crystal layer may be changed to cause various kinds of video information to be displayed on the display panel 10.

On the other hand, the display panel 10 may be provided with various different configurations and methods according to an exemplary embodiment. For example, in an exemplary embodiment using an OLED to implement the display panel 10, the backlight unit may be omitted.

The transmission member 40 is made of a transmittable material that transfer the image displayed on the display panel 10 to the user. For example, the transmission member 40 may be made of fabrics or a fine perforated sheet. Further, the transmission member 40 may be made of thin see-through fabrics (e.g., stockings material (nylon/polyurethane) or chiffon) having a plurality of through-holes 50 that are penetratingly formed along a thickness direction of the transmission member 40 so that sound of the display device 100 as well as the image of the display panel 100 can be easily transferred to the user.

A shape of the through-holes 50 of the transmission member 40 is not limited to a particular one. Examples of the shape of the through-holes 50 may include, but are not limited to, a polygon (triangle, rectangle, or hexagon) and a circle. In an exemplary embodiment, the through-holes 50 are in a rectangular mesh shape that corresponds to the shape of pixels of the display panel 10. As such, the image displayed on the display panel 10 may pass through the transmission member 40 to be projected onto the user's visual field without distorting the overall atmosphere of the image.

The transmission member 40 may have various colors in accordance with user's selection. A user may select the colors in consideration of the color and the size of the through-holes 50 in accordance with the illumination of the image or production of the use atmosphere.

The display device 100 may further include a cover frame 60 surrounding the transmission member 40 to support the transmission member 40. Referring to FIG. 3, the cover frame 60 may have a seating surface 64 arranged along the width direction of the display panel 10 and a fixing surface 62 vertically connected to the seating surface 64.

The seating surface 64 may have a shape and a size corresponding to an outer side surface of the display panel 10. That is, in a state where the transmission member 40 is attached to the vertical surface 62, the seating surface 62 may be fitted and engaged with the outer side surface of the display panel 10 to be easily detached from the display panel 10. Further, the transmission member 40 may be kept to be spaced apart from the display panel 10 or the diffusion member 30 for a predetermined gap distance D1, and the user can adjust the distance between the diffusion member 30 and the transmission member 40 by adjusting the position of the cover frame 60.

The diffusion member 30 may be arranged between the display panel 10 and the transmission member 40, and preferably, may come in contact with the front surface of the display panel 10. The diffusion member 30 may diffuse the light (image) provided from the display panel 10. The diffusion member 30 may be a light diffuser that diffuses the light emitted from the display panel (pixels of the display) 10 or a light guide plate.

For example, the diffusion member 30 may have a shape that corresponds to the display panel 10, and may be attached to a front edge portion of the display panel 10 through an adherer or adhesives. Different methods may be used to attach the diffusion member 30 to the display panel 10. For example, the diffusion member 30 may be detachably attached to the display panel 10 using a magnetic force (e.g., magnet or electromagnet).

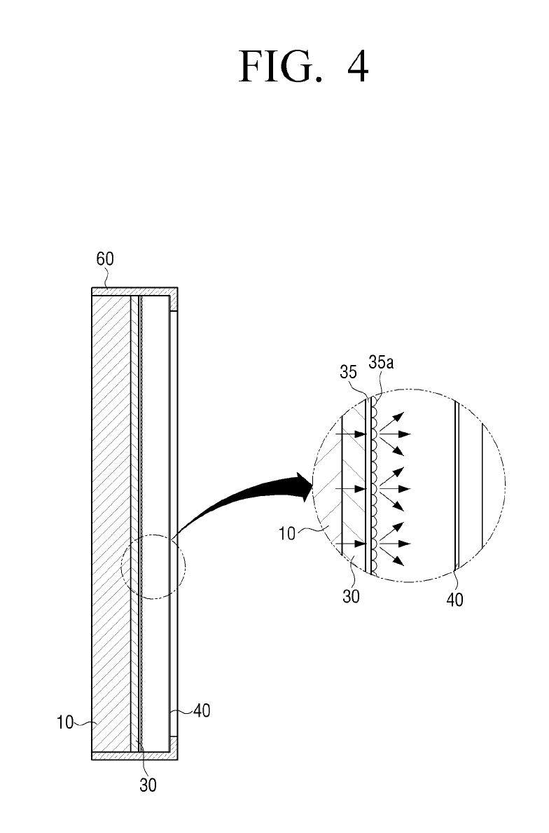

FIG. 4 is an enlarged view of a diffusion member illustrated in FIG. 3. As illustrated in FIG. 4, the diffusion member 30 may diffuse light that expresses an image on the display panel 10 and transfers the diffused light to the transmission member 40. On the front surface of the diffusion member 30, a diffusion film (or diffusion sheet) 35 may be arranged to diffuse once again the light that has passed through the diffusion member 30.

On the front surface of the diffusion film 35, a plurality of beads 35a may be formed. The light that has passed through the diffusion member 30 has uniform luminance in all directions, and may be re-diffused through the plurality of beads 35a of the diffusion film 35 to heighten the luminance of the vertically emitted light.

A shape of the bead 35a of the diffusion film 35 may vary according to an exemplary embodiment in consideration of the quantity and distribution of the emitted light. Examples of the shape of the bead 35a include, but are not limited to, an ellipse, a circular truncated cone, and a polygon. For example, if the bead 35a is in a circular shape, the light that is emitted from the display panel 10 is refracted when it passes through the bead 35a. As the curvature of the bead 35a becomes closer to a sphere, the angle distribution of the refracted light becomes wider. Thus, the distribution of the refracted light may be dependent on the shape or/and arrangement of the bead 35a. That is, the light that has passed through the diffusion member 30 and the diffusion film 35 may be transferred to the transmission member 40 to effectively prevent moiré pattern by adjusting the shape or/and arrangement of the bead 35a.

A reverse prism type pattern may be formed on the rear surface of the diffusion member 30. Accordingly, the incident light at small incident angle against the rear surface of the diffusion member 30 may be transferred to the transmission member 40 after passing through the diffusion member 30.

According to an exemplary embodiment, the diffusion member 30 may be used alone, or the diffusion member 30 may be replaced by the diffusion film 35. Further, the diffusion film 35 is not limited in thickness and kind, and a protection film may be laminated on the diffusion film 35.

As aforementioned, the diffusion member 30 may diffuse the light that is provided from the pixels of the display panel 10, and the light that is diffused through the diffusion member 30 is transferred to a user after passing through the transmission member 40. In the case where only the transmission member 40 is installed in front of the display panel 10 without the diffusion member 30 and/or the diffusion film 35, moiré pattern is likely to occur by overlapping of particles of the transmission member 40 on the pixels of the display panel (screen) 10.

However, according to an exemplary embodiment, since the diffusion member 30 is installed between the display panel 10 and the transmission member 40 to diffuse the light of the pixels of the display panel 10, the moiré pattern can be prevented from occurring, and more natural and clear colors can be provided to a user.

In addition, since the diffusion member 30 is attached to the front of the display panel 10, impacts of an outside to the display panel 10 can be minimized. Further, the diffusion member 30 and the transmission member 40 that are installed in front of the display panel 10 may prevent the display panel 10 from being directly exposed to an outside, and thus the display panel 10 can be protected from pollutants, such as user's fingerprints.

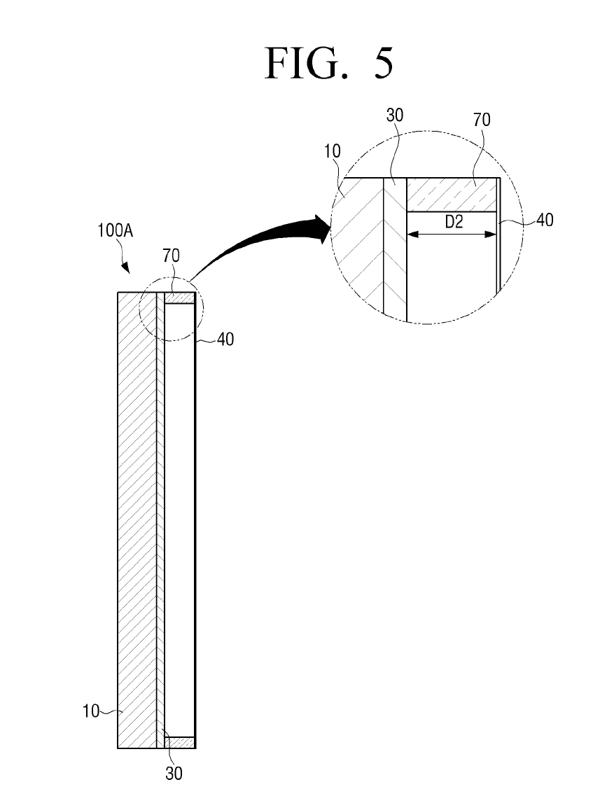

FIG. 5 illustrates a display device according to another exemplary embodiment. As illustrated in FIG. 5, a display device 100A may be configured in a manner that the transmission member 40 is fixed to be spaced apart from the front portion of the diffusion member 30 for a predetermined gap distance D2 using a spacer 70 instead of the cover frame 60. In other words, the gap distance D2 may be adjusted using the spacer 70. A shape of the spacer 70 may vary according to an exemplary embodiment. For example, the spacer 70 may be in a cylindrical shape. The transmission member 40 may be fixed to one side portion of the spacer 70 by bonding, and the display panel 10 (or diffusion member 30) may be fixed to the other side of the spacer 70 by bonding.

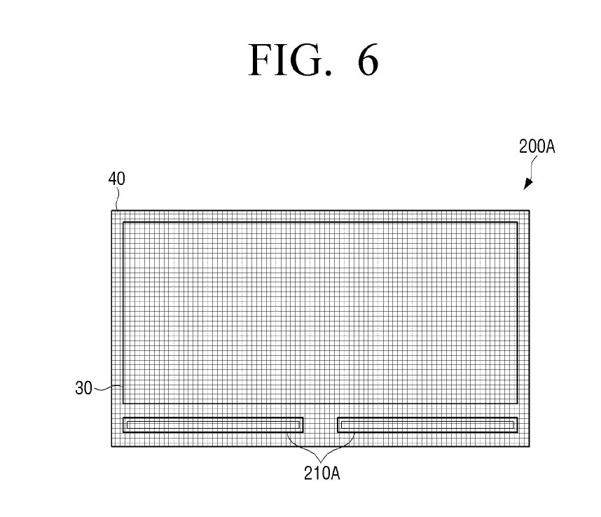

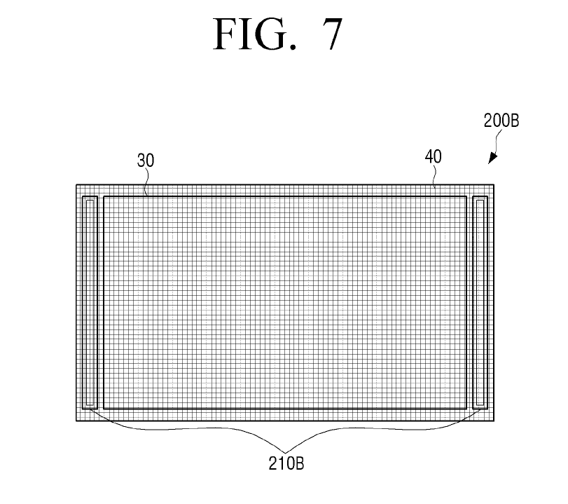

FIG. 6 is a view schematically illustrating a display device according to another exemplary embodiment. FIG. 7 is a front view of the display device illustrated in FIG. 6. For convenience in explanation, the features analogous to those of the display device 100, which have been described above with reference to FIGS. 1 to 5, will not be repeatedly described here. As illustrated in FIGS. 6 and 7, a display device may include one or more sound portions 210A and 210B arranged on a front portion thereof that is the same side as the surface of the display panel 10.

The diffusion member 30 may be attached to the display panel 10, and the transmission member 40 may be installed to accommodate the diffusion member 30 (or display panel 10) and the sound portions 210A and 210B. Accordingly, the image that is provided from the display panel 10 may be transferred to the transmission member 40 through the diffusion member 30 to prevent the moiré pattern from occurring, and the sound that is generated from the sound portions 210A and 210B may be effectively provided to the user through the transmission member 40.

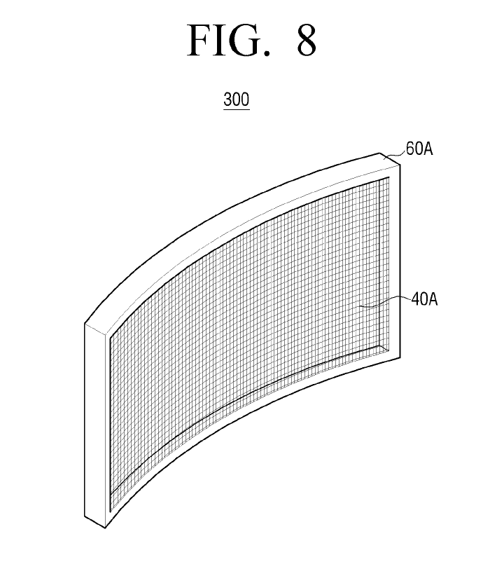

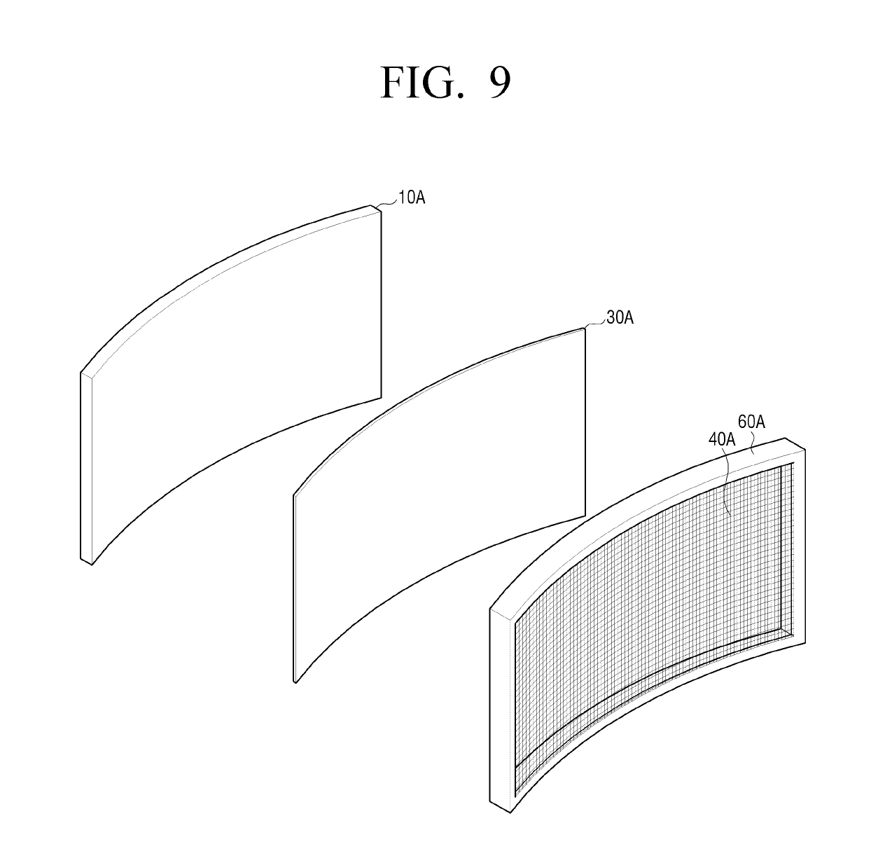

FIG. 8 is a view schematically illustrating a display device according to yet another exemplary embodiment. FIG. 9 is an exploded view of the display device illustrated in FIG. 8. For convenience in explanation, the features analogous to those of the display device 100, which have been described above with reference to FIGS. 1 to 5, will not be repeatedly described here. As illustrated in FIGS. 8 and 9, a display panel 10A of a display device 300 may be formed to be curved.

For example, the center portion of the display panel 10A may be in a concave (or convex) shape. In this case, the both ends of the display panel 10A project toward the front side in comparison to the center portion to form a curved surface, and thus a user can feel stereoscopic effects from a two-dimensional (2D) image that is displayed on such a curved display screen. A diffusion member 30A and a transmission member 40A that are installed in front of the display panel 10A may be also in a concave (or convex) shape corresponding to the shape of the front surface of the display panel 10A.

That is, the diffusion member 30A and a cover frame 60A may be made of a flexible material that can be bent or flexed. In a state where the transmission member 40A that is fixed to the cover frame 60A is fixed on a vertical surface of the cover frame 60A, a seating surface 64A is fixedly seated on the outer side surface of the display panel 10, and thus the transmission member 40A can keep a uniform gap distance from the front surface of the display panel 10A.

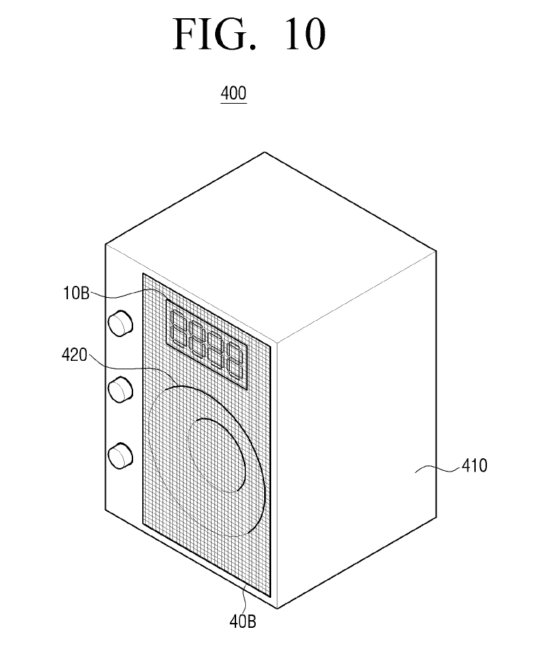

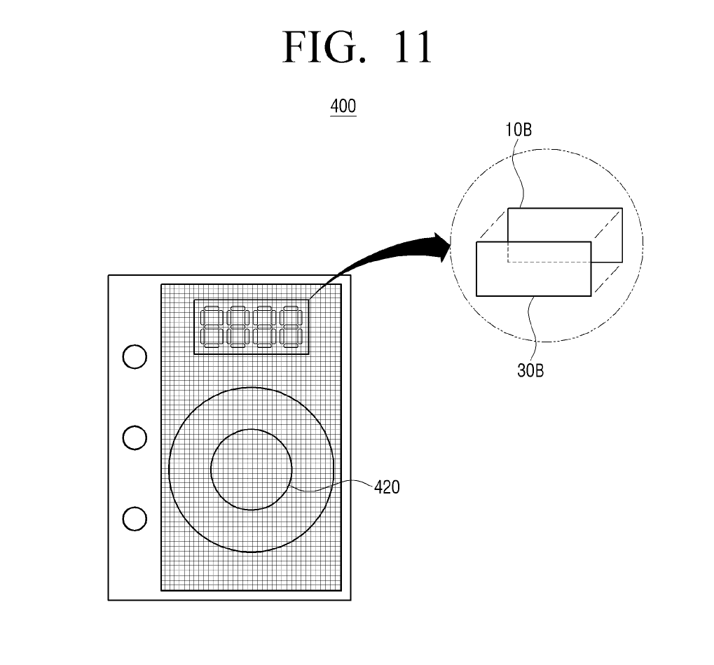

FIG. 10 is a view schematically illustrating a display device according to yet another exemplary embodiment. FIG. 11 is a front view of the display device illustrated in FIG. 10.

As illustrated in FIGS. 10 and 11, a display device 400 may be manufactured in a body with a speaker 410. For example, a sound signal can be reproduced through a woofer 420 arranged on one surface of the speaker 410. The speaker 410 may further include a tweeter or a midrange installed on one side of the same surface of the woofer 420.

A display panel 10B may be installed on the other side on the same surface as the woofer 420 to display an image. A diffusion member 30B is attached to the front surface portion of the display panel 10B, and a transmission member 40B may be installed on one surface of the speaker 410 to be spaced apart from the diffusion member 30B for a predetermined gap distance, covering the speaker 410 and the display panel 10B for protection.

That is, the display device 400 is coupled to one surface of the speaker 410 in a manner that a sound may be effectively transferred to a user. In particular, a moiré pattern may occur on the image of the display panel 10B due to the installation of the transmission member 40B. Also, the diffusion member 30B is installed on the front surface of the display panel 10B, and thus a moiré pattern which may occur on the image of the display panel 10B due to the speaker cover, i.e., transmission member 40B, may be prevented and an accurate image can be provided to the user.

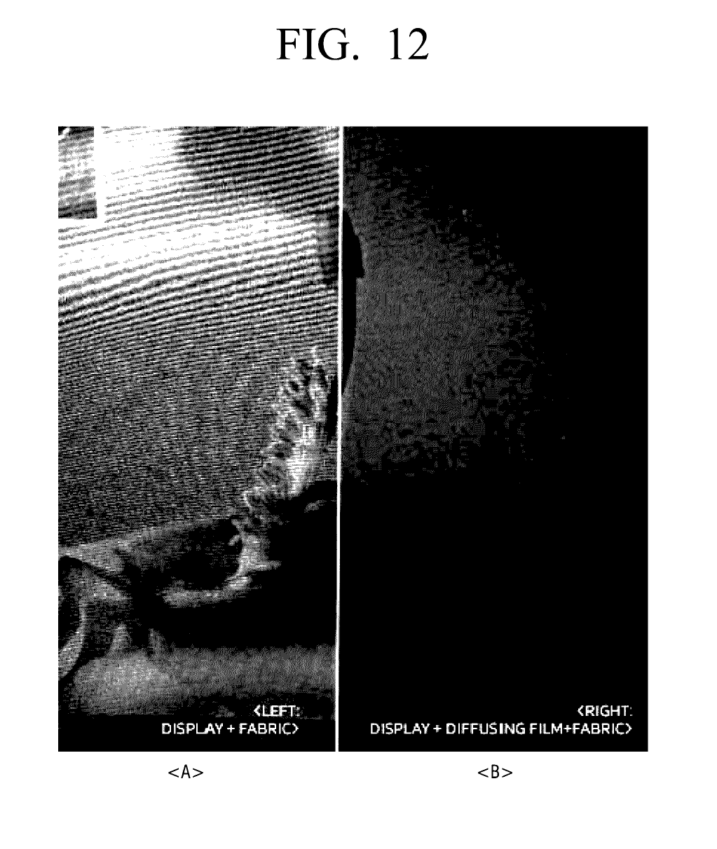

FIG. 12 is a view illustrating a screen of a display device according to an exemplary embodiment. Left view A of FIG. 12 illustrates a screen with moiré pattern, which can be seen when a transmission member is installed in front of a display panel. In contrast, right view B of FIG. 12 illustrates a screen without moiré pattern, which can be seen when a diffusion member is installed between a display panel and a transmission member according to an exemplary embodiment.

Since the diffusion member 30 is installed between the display panel 10 and the transmission member 40 to diffuse light of pixels of the display panel 10, the moiré pattern, which is likely to occur when only the transmission member 40 is installed, can be prevented from occurring, and thus more natural and clear colors can be provided to a user.

The display device including the filter device and the cover frame as described above is not limitedly applied to the configurations of the exemplary embodiments, but various modifications of the above-described embodiments may be made through combination of the exemplary embodiments.

As described above, the display device according to the exemplary embodiments can be implemented through various types of electronic devices. For example, the display device may be implemented by a TV, electronic photo frame, kiosk, audio player, or advertisement board.

Although the exemplary embodiments have been individually described, the configurations and operations of the respective embodiments may be implemented in combination with other embodiments.

The foregoing exemplary embodiments and advantages thereof are merely exemplary and are not to be construed as limiting the present disclosure. The exemplary embodiments can be readily applied to other types of apparatuses. Also, the description of the exemplary embodiments are intended to be illustrative, and not to limit the scope of the claims, and many alternatives, modifications, and variations will be apparent to those skilled in the art.

What is claimed is:

1. A display device comprising:
a display panel configured to display an image;
a transmission member arranged in front of the display panel and configured to transfer light that is projected from the display panel to express the image; and
a diffusion member arranged between the display panel and the transmission member, and configured to diffuse the light, and transfer the diffused light to the transmission member.

2. The display device as claimed in claim 1, wherein the diffusion member is attached to a front surface portion of the display panel, and
wherein the transmission member is arranged to be spaced apart from the diffusion member for a predetermined gap distance.

3. The display device as claimed in claim 1, wherein the transmission member is made of a fabric material.

4. The display device as claimed in claim 1, wherein the transmission member has a plurality of through-holes that are penetratingly formed in a thickness direction of the transmission member.

5. The display device as claimed in claim 4, wherein the through-holes are in a rectangular shape and are arranged in a mesh pattern.

6. The display device as claimed in claim 1, wherein the diffusion member is a diffusion film that diffuses the light emitted from the display panel.

7. The display device as claimed in claim 1, further comprising a cover frame surrounding the transmission member to support the transmission member, the cover frame being detachably attached to the display panel.

8. The display device as claimed in claim 1, further comprising a spacer which is arranged between the diffusion member and the transmission member, and adjusts a gap distance between the diffusion member and the transmission member.

9. The display device as claimed in claim 1, wherein the transmission member and the diffusion member have shapes corresponding to a front surface of the display panel.

10. The display device as claimed in claim 1, further comprising a sound portion arranged on the same side as the display panel,
wherein the transmission member is installed to accommodate the display panel and the sound portion.

11. A filtering device comprising:
a diffusion member configured to diffuse light which is projected from a display panel to express an image; and
a transmission member configured to transfer the light diffused by the diffusion member.

12. The filtering device as claimed in claim 11, wherein the transmission member has a plurality of through-holes that are penetratingly formed in a thickness direction of the transmission member.

13. The filtering device as claimed in claim 12, wherein the plurality of through-holes are in a rectangular shape and are arranged in a mesh pattern.

14. The filtering device as claimed in claim 11, wherein the transmission member is made of a fabric material.

15. The filtering device as claimed in claim 11, further comprising a diffusion film which is attached to the diffusion member and re-diffuses the light diffused by the diffusion member.

16. The filtering device as claimed in claim 15, wherein the diffusion film has a plurality of beads that heighten luminance of light which is emitted from the display panel vertically to the diffusion member.
